(19) United States
(12) Patent Application Publication
(10) Pub. No.: US 2013/0010115 A1
(43) Pub. Date: Jan. 10, 2013

(54) VEHICLE HAVING A REVERSING CAMERA

(75) Inventors: Christian Rudolf JERUSALEM, Mainz-Kastel (DE); Ingobert LASSRICH, Trebur (DE)

(73) Assignee: GM GLOBAL TECHNOLOGY OPERATIONS LLC, Detroit, MI (US)

(21) Appl. No.: 13/542,849

(22) Filed: Jul. 6, 2012

(30) Foreign Application Priority Data
Jul. 8, 2011 (DE) 10 2011 106 957.0

(51) Int. Cl. H04N 7/18

(52) U.S. Cl. 348/148; 348/E07.085

(57) ABSTRACT

A vehicle is provided having a camera, in particular a reversing camera, and a cleaning device, which is used for cleaning an optical surface that interacts with the camera. The cleaning device has a cleaning element, which has a cleaning action on the optical surface due to a relative motion between the cleaning element and optical surface. Additionally or alternatively, the cleaning device has a moistening unit, by which a liquid media stream can be applied against the optical surface.

### CROSS-REFERENCE TO RELATED APPLICATION

This application claims priority to German Patent Application No. 10 2011 106 957.0, filed Jul. 8, 2011, which is incorporated herein by reference in its entirety.

### TECHNICAL FIELD

The technical field relates to a vehicle having at least one camera, in particular a reversing camera, and a cleaning device which is used for cleaning an optical surface that interacts with the camera. The technical field also relates to a cleaning device, which is used in such a vehicle to clean an optical surface that interacts with the camera of the vehicle.

### BACKGROUND

Modern vehicles increasingly comprise driver assistance systems which support the driver actively or passively when driving the vehicle and provide assistance where necessary. Usually the assistance systems process a plurality of information items which are captured by sensors on and/or inside the vehicle. For example, so-called camera-based systems are used, which are preferably used in electronic parking aids. These systems typically have at least one camera on the rear of the vehicle, by which the environment behind the vehicle is detected, or can be filmed. Usually the cameras switch on when reverse gear is engaged and display their image on a display in the cockpit. The cameras are usually mounted on the outside of the vehicle or are moved automatically from a starting position within the vehicle into a position outside of the vehicle in order to have clear sight of the area outside to be detected.

In practice it has been shown that the camera lens becomes slightly dirty due to external adverse weather conditions. Also, any protective surface placed upstream of the camera optics to protect the lens of the camera becomes dirty relatively quickly due to external adverse weather conditions. In order to prevent contamination of the camera in the region of its optics or an upstream protective surface, a cleaning device can be provided, triggered for example, automatically or by the driver, which cleans the camera and/or the upstream protective surface.

A possible cleaning device is described in DE 102 51 661 A1. There, it is provided that the camera optics is cleaned with compressed air. To achieve this, a compressor is to be provided by which the necessary compressed air is generated. Cleaning with compressed air is technically relatively complex and expensive.

In view of the foregoing, at least one object is to provide a vehicle with at least one camera, in particular a reversing camera, of the above-mentioned type, which facilitates the cleaning of the camera optics and/or a protective surface placed upstream of the optics in a technically simple and cost-effective manner. In addition, other objects, desirable features and characteristics will become apparent from the subsequent summary and detailed description, and the appended claims, taken in conjunction with the accompanying drawings and this background.

### SUMMARY

A vehicle, in particular a motor vehicle, has at least one camera, in particular a reversing camera, and a cleaning device which is used to clean an optical surface that interacts with the camera of the vehicle. The optical surface may be a component of the optics of the camera, for example, a lens of the camera, and/or a protective surface upstream of the camera optics. If the camera is a reversing camera, the camera is preferably designed to be arranged in the rear region of the vehicle.

The cleaning device comprises at least one cleaning element which has a cleaning effect on the optical surface due to a relative movement between the cleaning element and the optical surface. By this measure the optical surface is cleaned, in particular cleared of dust or dirty water, in a technically simple manner by the cleaning element being provided and having a cleaning effect due to the relative motion of cleaning element and optical surface. Such a cleaning device is also feasible to implement in a cost-effective way because to achieve this, only the cleaning element is necessary and the relative motion between cleaning element and optical surface is to be provided.

According to one embodiment, the cleaning element is in a cleaning position when it has a cleaning effect on the optical surface due to a relative movement between cleaning element and optical surface. This ensures that the cleaning element has a cleaning action on the optical surface when the cleaning element and the optical surface have been moved to the cleaning position, and the relative motion between cleaning element and optical surface can thereby take place.

It may be provided according to one embodiment that the optical surface is arranged such that it is stationary relative to the vehicle and the cleaning element is or can be moved from its starting position into the cleaning position. The cleaning element itself is thereby actively moved towards the optical surface and moved into the cleaning position. The cleaning element can be moved back to the starting position after the cleaning process. In the initial position the cleaning element is preferably located outside of the area within which the cleaning element has a cleaning action on the optical surface by means of the relative motion between cleaning element and optical surface.

The optical surface can be fixedly mounted on the vehicle, in particular mounted on the outside of the vehicle. The optical surface is thereby positioned on the vehicle with little technical effort. This also makes a simple mounting of the optical surface or camera possible, because complicated fittings, guides or the like are not necessary for the assembly of the optical surface or camera.

According to an alternative embodiment, the cleaning element can be arranged such that it is stationary relative to the vehicle and the optical surface is or can be moved from a starting position into the cleaning position. The optical surface is thereby actively moved into the cleaning position. If necessary, the optical surface together with the camera can be moved back into the starting position after the cleaning process. In the starting position the optical surface, together with the camera, is preferably located outside of the area within which the cleaning element has a cleaning action on the optical surface by means of the relative motion between the optical surface and cleaning element.

It can also be provided that the optical surface and the cleaning element are or can be moved from a respective starting position into the cleaning position. In this way, both the optical surface and the cleaning element must be set in motion in order to reach the cleaning position in which the cleaning element has a cleaning action on the optical surface with the relative motion of the optical surface and cleaning element.

The cleaning element which is used in one of the above mentioned configurations can be a wiper, for example, having a rubber lip which wipes over the optical surface, displacing dirt, dirty water or the like from the optical surface. The cleaning element or wiper can be designed to swivel about a pivot point. Also, the cleaning element or wiper can be designed to move linearly, for example in the manner of a linear wiper. The cleaning element can be guided on at least one guiding track for this purpose.

According to a further embodiment it is provided that the camera and/or the optical surface is designed for executing a feed motion from a rest position into a working position. The feed motion can be a translational motion or a rotary motion. Also, the feed motion can consist of a combination of a translational motion and/or a rotary motion.

An extension in the cleaning element is a stationary arrangement relative to the vehicle, so that during its feed motion the optical surface is moved past the cleaning element while being subject to a cleaning action of the cleaning element. The feed motion of the optical surface is thereby used to effect a cleaning thereof on the cleaning element. The cleaning element itself does not need to be moved to do so.

According to a further embodiment the cleaning element can be movable in such a manner that during its feed motion the optical surface is moved past the cleaning element while being subject to a cleaning action of the cleaning element. The cleaning of the optical surface is thereby supported by the additional movement of the cleaning element itself.

It is recommended that the optical surface is arranged in the rest position and/or starting position inside the vehicle. This means that the optical surface, and in particular together with the camera, are accommodated together in an environment or position that is protected from the outside when no detection of the environment by the camera is intended to take place. In addition, the optical surface and also preferably therefore the camera, are not visible from the outside in the rest position or starting position, so that the appearance of the vehicle remains unchanged.

Alternatively or in addition, it can be provided that in the rest position and/or starting position the optical surface is concealed from the outside by a part of the vehicle. For example, the optical surface, preferably together with the camera, can be covered by the logo of the vehicle in the rest or starting position. This measure also aims to ensure that in the starting position or rest position of the optical surface, i.e. when no detection of the environment by the camera is intended to be made, the cleaning element should not be visible to the observer from the outside.

It is conceivable for the vehicle to have a through hole in a side panel, through which the optical surface and/or the camera can be moved from the rest position into the working position. The through hole can be concealed by a cover, such as the identification badge or a logo of the vehicle manufacturer. The component can be mounted such that it can pivot, for example. It can also be provided that a section of the border of the through hole is designed to receive the cleaning element. Also, a section of the through hole can be implemented as a cleaning element itself. The section carries a sealing lip, for example, along which the camera and/or optical surface is wiped when moving out of the rest position into the working position, thereby cleaning the optical surface.

According to a further embodiment it is provided that the cleaning device has a moistening unit, by which a liquid media stream can be applied against the optical surface. With the liquid media stream, cleaning of the optical surface can already be carried out independently of the cleaning element. In addition, the media stream enables a removal of dirt from the optical surface, which can then be cleaned by means of the cleaning element as described above, for example, by the cleaning element moving the layer of dirt off the pre-moistened optical surface.

In accordance with another embodiment, the cleaning device has a moistening unit, by which a stream of liquid media is or can be applied against the optical surface. The cleaning device then has the moistening unit by which the optical surface is cleaned.

It is conceivable that before moving the optical surface and, where appropriate the camera, into the rest position, the liquid media stream is applied to the optical surface with the moistening unit and only then is the optical surface moved from the working position back into the rest position. In the course of moving of the optical surface into the rest position, the optical surface can then be moved past the cleaning element while being subject to a cleaning action of the cleaning element. The optical surface is thereby moved back into the rest position and is in the rest position having been cleaned with the media stream and cleaning element. Such a cleaning process can be carried out, for example, when no further detection of the environment is to be made by the camera and therefore a return motion of the optical surface and, where appropriate, the camera into the rest position is initiated.

It is recommended that the moistening unit has at least one nozzle element by means of which the liquid media stream is sprayed against the optical surface. This enables a particularly good cleaning effect to be achieved by the liquid media stream. Using the nozzle element it is it possible to break down the stream into a fine spray and to spray it onto the optical surface in a fine form. Also, the media stream can be sprayed at high pressure onto the optical surface.

A cleaning device is also provided for a vehicle of the above-described type, which is used to clean an optical surface that interacts with the camera of the vehicle.

### BRIEF DESCRIPTION OF THE DRAWINGS

The present invention will hereinafter be described in conjunction with the following drawing figures, wherein like numerals denote like elements, and:

FIG. 1 is an embodiment of a vehicle having a reversing camera and a cleaning device for cleaning the lens of the camera;

FIG. 2 is a further embodiment of a vehicle having a reversing camera and a cleaning device for cleaning the lens of the camera; and

FIG. 3 is the mode of operation of a further possible cleaning device for cleaning the lens of a reversing camera for a vehicle.

### DETAILED DESCRIPTION

The following detailed description is merely exemplary in nature and is not intended to limit application and uses. Furthermore, there is no intention to be bound by any theory presented in the preceding background or summary or the following detailed description.

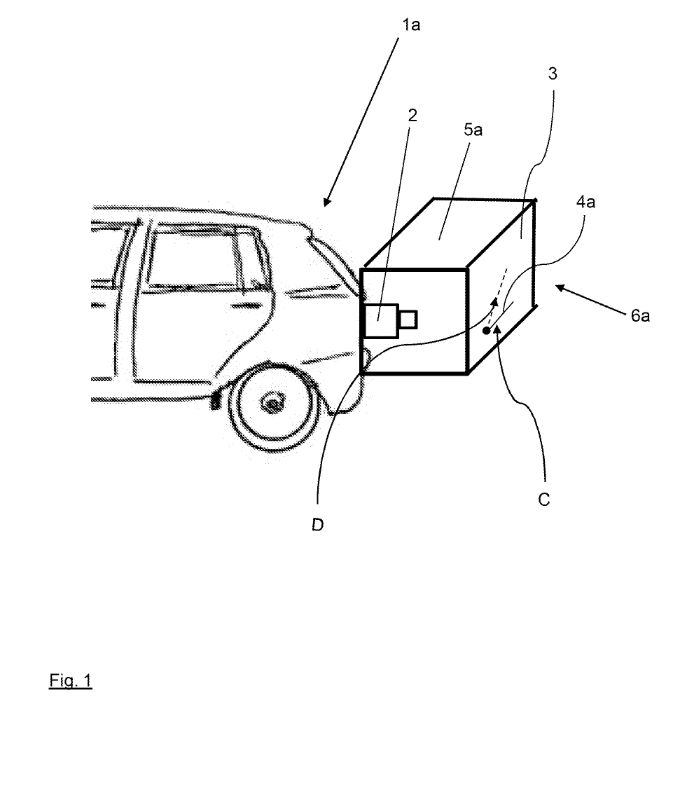

FIG. 1 shows a possible embodiment of a vehicle 1a, in particular a motor vehicle, which is equipped with a camera or reversing camera 2. The reversing camera 2 is surrounded by an enclosure 5a in order to be protected against external influences, for example mechanical influences. The enclosure 5a has a protective surface 3 which is upstream of the lens of the reversing camera 2 and is preferably made of transparent material. The protective surface 3 forms an optical surface that interacts with the camera. The enclosure 5a is mounted together with the reversing camera 2 on the outside of the vehicle 1a.

In addition, a cleaning device 6a is provided, which is used for cleaning the protective surface 3. For this purpose the cleaning device 6a has a cleaning element 4a which has a cleaning action on the protective surface 3 due to a relative movement between cleaning element 4a and protective surface 3. The cleaning element 4a in the embodiment of the cleaning device 6a according to FIG. 1 is implemented as a rotating wiper, which is preferably mounted on the protective surface 3 such that it can rotate about a rotational axis.

The cleaning element 4a, which preferably comprises a cleaning lip, in particular a rubber lip, can be transferred from a starting position C into a cleaning position D. In the initial position C the cleaning element 4a does not adversely affect the field of view captured by the reversing camera 2. In the starting position C the cleaning element 4a is preferably moved into a position that is protected from the outside, so that in the starting position C the cleaning element 4a is protected against potentially damaging external effects. In the cleaning position D the cleaning element 4a is located on the surface of the protective surface 3 to be cleaned and moves on the surface to be cleaned such that any areas of dirt or dirty liquid are pushed off, in particular wiped off, due to the contact of the cleaning element 4a with the surface.

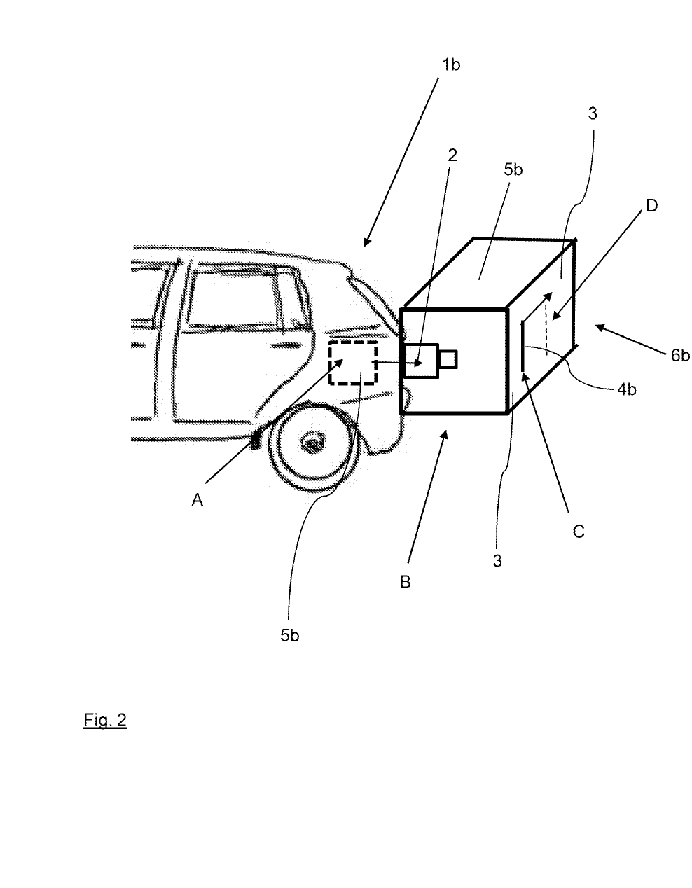

FIG. 2 shows a further possible embodiment of a vehicle 1b which is equipped with the reversing camera 2. Components of the embodiment of the vehicle 1b according to FIG. 2 that are identical or functionally equivalent to the components of the vehicle 1a according to FIG. 1 are labeled with the same reference numerals; to that extent, reference is made to the description of FIG. 1.

The vehicle 1b according to FIG. 2 differs from the vehicle 1a according to FIG. 1 by, inter alia, the fact that the reversing camera 2 is arranged inside an enclosure 5b, which can be moved together with the camera 2 from a rest position A into a working position B. In the rest position A, the enclosure 5b is preferably located together with the reversing camera 2 inside the vehicle 1b in a protected position. In the working position B the enclosure 5b is moved together with the reversing camera 2 into a position on the vehicle 1b, in which the reversing camera 2 is aligned towards the environment to be captured, preferably protruding from the vehicle 1b to the rear.

The embodiment of the vehicle 1b, in accordance with FIG. 2 differs from the embodiment of the vehicle 1a in accordance with FIG. 1 by, inter alia, the fact that a cleaning device 6b with a cleaning element 4b is provided for cleaning the protective surface 3 of the enclosure 5b, which device is implemented as a linear wiper. The cleaning element 4b can be moved from the position C (not visible in FIG. 2) into the cleaning position D and moves in the cleaning position D with a linear movement along the protective surface 3, in order to clean the viewing area of the protective surface 3 that is relevant to the reversing camera 2.

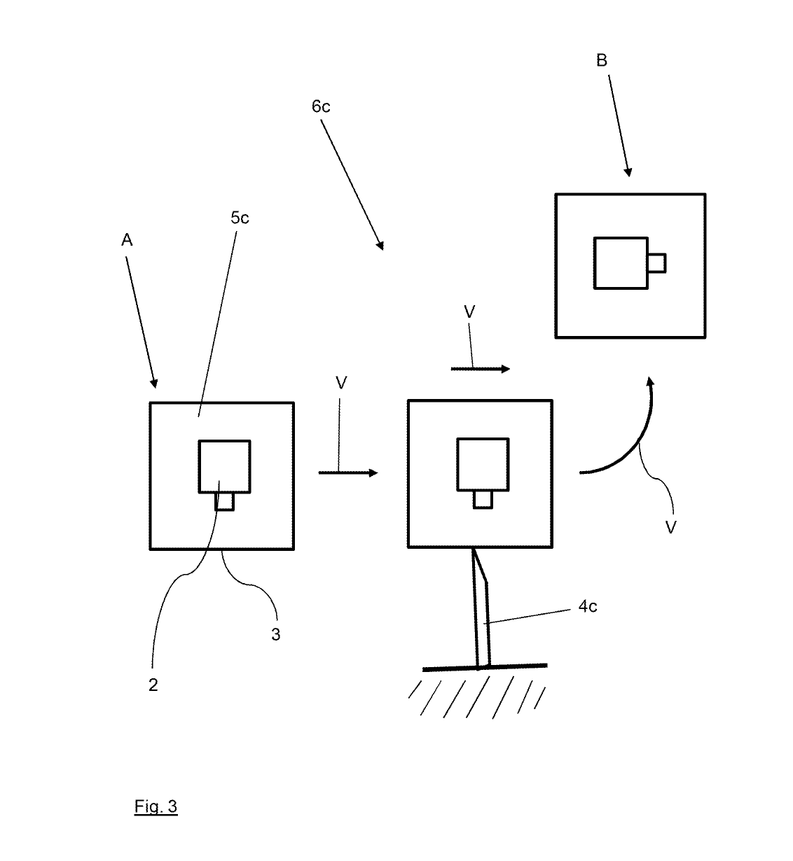

FIG. 3 shows in a conceptual illustration A a further possible embodiment of a cleaning device 6c for cleaning the reversing camera 2, or the protective surface 3 of an enclosure 5c in which the reversing camera 2 is integrated. The enclosure 5c is to be moved together with the reversing camera 2 from the rest position A into the working position B and in doing so executes a feed motion V. In the course of the feed motion V, the protective surface to be cleaned 3 is moved past the cleaning element 4c while being subject to a cleaning action of the cleaning element 4c.

The enclosure 5c can be moved by means of a linear feed motion together with the reversing camera 2 starting from the rest position A, and at the same time pass over the cleaning element 4c with a cleaning action. For this purpose the enclosure 5c can be aligned with its protective surface 3 facing downwards. After passing over the cleaning element 4c the feed motion V can extend in the shape of an arc, so that the enclosure 5c, together with the reversing camera executes a rotation through an angle of approximately 90° and then the protective surface 3 of the enclosure 5c is positioned substantially vertically, in particular the reversing camera is aligned in the specified position to capture the specified range.

The cleaning device 6c in accordance with FIG. 3 can also act in such a manner that cleaning of the protective surface 3 takes place when the enclosure 5c together with the reversing camera 2 is moved from the working position B back into the rest position A. Also, it may be self-explanatory that according to a further configuration, cleaning takes place both when moving from the rest position A to the working position B, and back from the working position B to the rest position A.

The possible embodiments of the cleaning device 6a, 6b, 6c described in FIG. 1, FIG. 2 and FIG. 3 can, of course, also be implemented without an enclosure. In this case, the respective cleaning element 4a, 4b, 4c acts with a cleaning effect directly on the optics of the reversing camera 2, for example as a lens of the reversing camera 2.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A vehicle, comprising:
a reversing camera;
an optical surface that interacts with the reversing camera;
a cleaning device that is configured to clean the optical surface; and
a cleaning element of the cleaning device configured to provide a cleaning action on the optical surface due to a relative motion between the cleaning element and the optical surface.

2. The vehicle according to claim 1, wherein in a cleaning position the cleaning element is configured to provide the cleaning action on the optical surface due to the relative motion between the cleaning element and the optical surface.

3. The vehicle according to claim 2, wherein the optical surface is arranged stationary relative to the vehicle and the cleaning element is movable from a starting position into the cleaning position.

4. The vehicle according to claim 1, wherein the optical surface is fixedly mounted on the vehicle.

5. The vehicle according to claim 1, wherein the optical surface is fixedly mounted on the outside of the vehicle.

6. The vehicle according to claim 2, wherein the cleaning element is arranged stationary relative to the vehicle and the optical surface is configured to move from a starting position into the cleaning position.

7. The vehicle according to claim 2, wherein the optical surface and the cleaning element are configured to move from a respective starting position into the cleaning position.

8. The vehicle according to claim 1, wherein the optical surface is configured to execute a feed motion from a rest position into a working position.

9. The vehicle according to claim 1, wherein the optical surface is configured to execute a feed motion from a rest position into a working position.

10. The vehicle according to claim 8, wherein the cleaning element is arranged stationary relative to the vehicle so that the optical surface is moved past the cleaning element during the feed motion while subjected to the cleaning action of the cleaning element.

11. The vehicle according to claim 8, wherein the cleaning element is configured to move such that the optical surface is moved past the cleaning element during the feed motion while subjected to the cleaning action of the cleaning element.

12. The vehicle according to claim 8, wherein in the rest position the optical surface is arranged inside the vehicle by a component of the vehicle.

13. The vehicle according to claim 8, wherein in the rest position the optical surface is concealed from the outside by a component of the vehicle.

14. The vehicle according to claim 6, wherein in the starting position the optical surface is arranged inside the vehicle by a component of the vehicle.

15. The vehicle according to claim 6, wherein in the starting position the optical surface is concealed from the outside by a component of the vehicle.

16. The vehicle according to claim 1, further comprising a moistening unit that is configured to apply a liquid media stream against the optical surface.

17. The vehicle according to claim 16, wherein the moistening unit comprises a nozzle element that is configured to spray the liquid media stream against the optical surface.
